(19) United States
(12) Patent Application Publication
(10) Pub. No.: US 2010/0065610 A1
(43) Pub. Date: Mar. 18, 2010

(54) Wide wave apparatus for soldering an electronic assembly

(76) Inventor: Richard Anthony Szymanowski, Bullock, NC (US)

Correspondence Address: RICHARD A. SZYMANOWSKI, 9195 DAVE WINSTON RD., BULLOCK, NC, 27507, US

(21) Appl. No.: 12/583,367

(22) Filed: Aug. 19, 2009

Related U.S. Application Data
(60) Provisional application No. 61/136,556, filed on Sep. 15, 2008.

(51) Int. Cl. B23K 3/06; B23K 1/08

(52) U.S. Cl. 228/37

(57) ABSTRACT

Especially for but not limited to lead-free solder, the apparatus disclosed herein will provide better quality of wave soldered joints at a lower cost, without the addition of more equipment.

The invention will form complete TH solder joints over the first wave soldering nozzle, not the second wave soldering nozzle which is current art. It specifically addresses the size and the shape of the holes in the first wave-forming nozzle.

The first solder wave forming plate has hexagon shaped holes that reduce the incidence of holes being clogged and non-functional. There is a size gradient across the multiple rows of holes in the extended contact wave former that has the effect of creating a uniform solder pressure across the entire face of the nozzle. The result is higher solder pressure against the electronic substrate being soldered for a longer period of time than current art, allowing for faster formation of solder joints. This affects quality and thru-put.

Priority for this invention is claimed by virtue of the associated provisional patent application No. 61/136,556. The filing date was Sep. 15, 2008. The confirmation number was 7875.

### BACKGROUND OF INVENTION

1. Field of Invention

This application relates to the general business of electronics manufacturing, and specifically to a common soldering process used in that business. The specific process is called wave soldering and it provides for the mechanical and electrical connection of components to a substrate with molten solder alloy. As a definition of terms, a wave solder machine is a mass soldering machine system, where molten solder is pumped up to form a standing wave, while the product is passed over that wave, thereby forming many solder joints that are uniform, at high efficiency. The machine automatically transports the product across the required process steps to make a solder joint, which includes flux application, pre-heat, and soldering. This application will focus only on the apparatus used to form the solder wave, and this apparatus is both unique in design and function, resulting in improved soldering efficiency and reduced defects.

2. Discussion of Related Art

Fundamental to the entire electronics manufacturing industry is the requirement to make a series of electrical and mechanical connections, with a solder alloy, thereby creating an electrical circuit, and with final assembly, a functional device (a PWBA). While product design and manufacturing needs have changed, the industry norm for wave soldering has not fundamentally changed for over 40 years.

The solder module in the typical wave solder machine often has two solder nozzles because the assemblies being produced may have a mixture of components that create two different situations in the wave soldering process. Until very recently, the solder has not changed, being a tin-lead alloy. Families of components that were assembled through holes (TH components) in the circuit substrate continue to remain in use. Within the last 20 years, a general group of components has developed that are soldered only to the surface of the substrate (SMT). In current art wave soldering this resulted in adding a second wave-soldering nozzle ahead of the pre-existing solder nozzle. The new solder nozzle duplicated the current art technology except that it is a very turbulent, and narrow solder wave being placed ahead of the pre-existing second solder wave, which was wider and less turbulent.

This first solder wave was not designed to create a solder joint for the TH electrical components and is always located ahead of the larger, smooth wave. The design intent of the first wave was to create solder joints on the small SMT parts that had very restricted access. The second wave remained as the tool that created the larger and heavier solder joints on both SMT and TH components.

In recent years, two significant changes have taken place, making the above process less efficient, more expensive and, in many cases, inadequate.

First, environmental concerns, often mandated by international legislation, have led to the increased use of solder that is free of lead. Second, the product to be wave soldered has become more complicated and the demand for quality and cost improvement have been emphasized.

With lead-free soldering, current art wave solder machines and processes have difficulty in overcoming the fundamental lead-free alloy attributes of a higher melting temperature and slower wetting speeds. These attributes are the root cause problems to all the issues noted. These alloy limitations cannot be addressed simply with a different soldering flux or higher temperatures, because the electrical assemblies cannot survive those conditions. While a logical solution would be to design more compatible PWBA, the industry has actually emphasized the opposite, creating new products that are more difficult to solder in any manner.

In current art wave-soldering machines the first solder nozzle is a narrow and aggressive solder wave form that does not provide the contact time or the solder pressure to the face of the PWBA, as does the invention. The result is a partially completed TH solder joint.

In current art, especially in lead-free soldering, a leading defect is the inability to achieve fully formed solder joints on the entire assembly, with either one or two solder nozzles being used. Associated problems affect cost, productivity and quality.

In current art, there are the following problems associated with the solder results of using the first solder nozzle: a) A partially completed solder joint will immediately loose its solder-ability because of oxide formation over the partial joint. b) Solder flux, present above the partial joint will deteriorate with the process temperature, and provide less support to completing the joint formation at the second nozzle. c) As the first solder nozzle is spaced away from the second solder nozzle, any partial solder joint will solidify, and it must be re-melted and re-activated at the second wave, to complete a joint. These problems result in slower production rates, more defects and an associated increase in production costs.

In summary, existing wave solder machine soldering, with lead-free solder alloy, is now slower, with more production defects, and there is concern that the current art will foster less reliable product and latent field failures. When more defects are made at primary assembly, there is more cost and a long-term reliability concern associated with those repaired items. Reduced thru-put and quality concerns drive increased operating and overhead costs.

In a careful review of the current product designs, materials used in wave soldering, the need for reliability, cost control, and the operational environment in a mass-production factory, two key design attributes for the invention were developed: 1. Specifically at the first wave, the dynamics of the solder contact would be changed. 2. The performance of the soldering flux and pre-heat modules that precede the solder module would be optimized.

The invention provides a wave soldering system that will allow faster throughput speeds and lower defects when wave soldering, especially with lead free solder. It will improve the wave solder capability to manufacture the newer and more challenging product designs. It is equally effective with traditional tin-lead solder alloys.

### BRIEF SUMMARY OF INVENTION

The innovation and value of the invention goes directly to the first solder nozzle form. The most significant attributes of the invention are the optimization of the soldering flux used in the process, and superior solder flow dynamics, both of which contribute to correcting the lead-free solder problems of un-filled solder joints and reduced machine through-put.

Instead of the traditional first solder nozzle that is a narrow solder wave form that was not designed to solder TH components, the first nozzle becomes an extended flat surface with an array of multi-sided holes, through which molten solder is pumped, creating a very turbulent solder wave form that has exceptionally strong vertical force vectors, more efficient thermal energy transfer, higher solder pressure against the substrate, and, extended solder contact. The multi-sided holes resist becoming clogged.

The effect of soldering flux is not diminished by a short contact to molten metal, as in current art, and because of the preserved flux, nitrogen ahead of the new nozzle is not mandatory. Where current art uses a second solder wave to make the complete solder joint, the invention has generally already completed making those joints while on the first wave. The invention uses the second wave to primarily remove excess solder.

Briefly, the invention is a first solder nozzle of extended width, at an angle of three to seven degrees, which is parallel to the travel of the PWBA on the machine conveyor. Across the face of this solder nozzle are from three to nine rows of multi-sided apertures which are typically hexagon shaped, but are neither round, oval, square, nor rectangular, through which solder is pumped to create a turbulent wave form. Last, progressing along the angle of the invention, the apertures in the solder nozzle wave former change in size to create a uniform height and pressure in the wave-form.

### BRIEF DESCRIPTION OF DRAWINGS

The accompanying drawings are not drawn to scale. For purposes of clarity, not every component may be labeled in every drawing. In the drawings:

FIG. 1 and FIG. 2 provide a general description of the system in which the invention is used. Specific comparison between the invention and current art are detailed in FIG. 3 and in FIG. 4. The unique aspects of the invention are shown in FIG. 5.

FIG. 1 is a representative view of a wave soldering machine system with the invention installed. The view shows the relationship between the main modules in the machine system, and the relative location of where the invention is located. Electronic substrates 20 are diagramed to show their travel up the conveyor 2 and through the machine system 1.

FIG. 2 is the same representation of the wave solder system except that it displays the current art version in the location of the first solder nozzle.

FIG. 3 is a cross-sectional view of the current art solder nozzles, taken across the solder pot. It displays the relative position and travel direction of the conveyor, and the relative size and location of the first solder wave, in a solder pot.

FIG. 4 is a cross-sectional view of the invention, taken across the solder pot. It also displays the relative position and travel direction of the conveyor and the relative size and location of the first solder wave, which is the invention. In FIG. 4, the wave forming plate 13, which is a key element in the invention, is identified and located.

FIG. 5 is an expanded view of the wave forming plate 13, which is where the solder wave of the first nozzle is actually created by solder being pumped through the nozzle 12. Hole shape and size are diagrammatically represented.

### DETAILED DESCRIPTION OF THE INVENTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

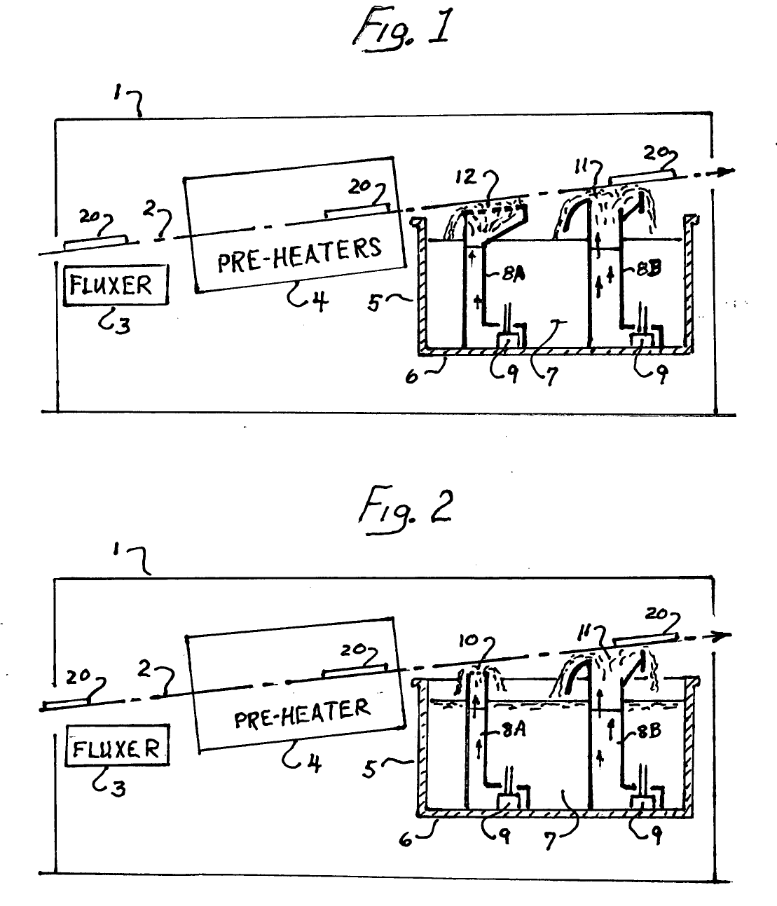

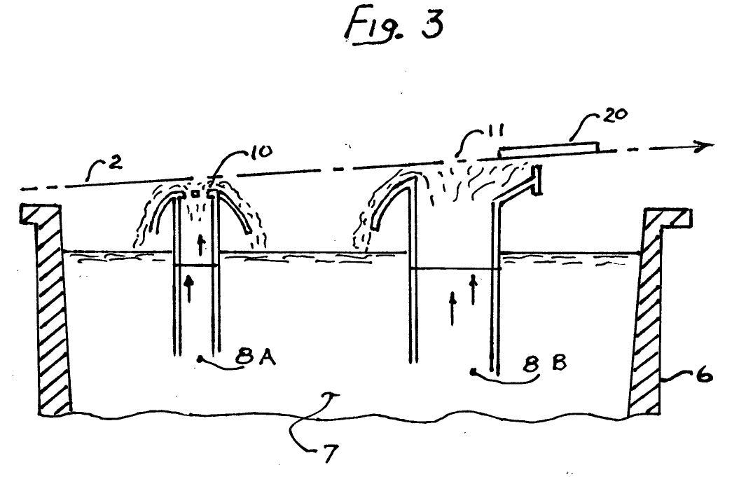

Starting with FIG. 1 and FIG. 2, the only difference in the wave solder process is by installing the invention 12 as the first solder wave 10 located in the solder pot 6. The machine system 1 is not otherwise affected. Electronic substrate 20 to be soldered, are put on the machine conveyor 2. The conveyor 2 carries the substrate 20 over the flux module 3, through the pre-heat module 4 and through the solder module 5, after which the electronic substrate 20 are conveyed out of the machine as soldered assemblies. In the solder module 5, there is a heated reservoir, or solder pot 6 keeping the solder at an operating temperature. Solder pumps 9 push the molten alloy 7 through flow channels 8A and 8B up to the solder nozzles 10 and 11, where the solder waves are formed and the actual soldering process takes place. Distinction is placed on the difference between the first wave flow channel 8A and the second wave flow channel 8B because they are different sizes and the space between the two flow channels is a design consideration in the invention.

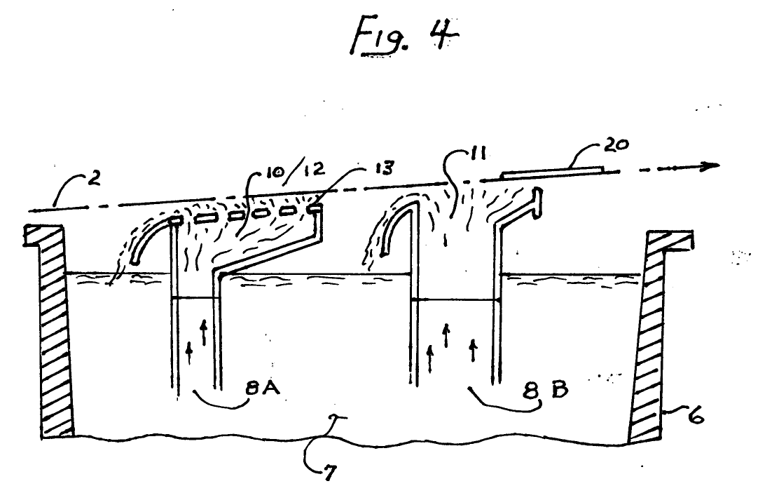

The reasons for the performance improvement of the invention over current require an explanation of FIG. 3 versus FIG. 4. In the background of current art wave soldering it is explained that especially with lead-free soldering the current art fails to provide the desired production speed and quality. From technical fact, successful wave soldering requires sufficient heat into the solder joint and clean surfaces. It is also explained that while soldering flux is designed to clean the joint surfaces and to keep those surfaces clean until soldered, it is an organic material that is laid on the surfaces to be soldered. For this discussion that means that it can be degraded with time and heat, at which time it cannot support complete, solder joint formation. It can also be depleted in activity and volume by brief contact with a narrow solder wave before the actual solder joint is fully formed, and at the second solder wave there is insufficient flux to support formation of a complete solder joint.

In FIG. 3, an electronic substrate 20 located immediately ahead of the first solder wave 10 would ideally have the optimum pre-requisites to create a solder joint, except the actual solder. Because the current art first solder wave 10 was designed for small SMT, it is neither designed nor capable of making a complete TH solder joint by itself. The solder contact area is small and there are no unique forces to maximize thermal transfer from the solder wave into the solder joint. It is required to complete the solder joint over the second solder wave 11.

When double wave, current art wave soldering is attempted three detrimental situations have been launched. First, the first wave 10 has rinsed away some of the flux making it more difficult for the second solder wave 11 to make a complete joint. Second, the first wave 10 does not have the capability to create a complete TH solder joint, so there is a partially filled solder joint, where the exposed surfaces above the partial fill are subject to oxidation, again inhibiting future solder joint formation. Last, FIG. 13 shows a relatively large physical distance between nozzle 10 and nozzle 11, where the partial solder joint cools and oxidation occurs over the partial fill. The second nozzle 11 must now re-melt the partial fill and overcome a less solderable surface to complete a solder joint.

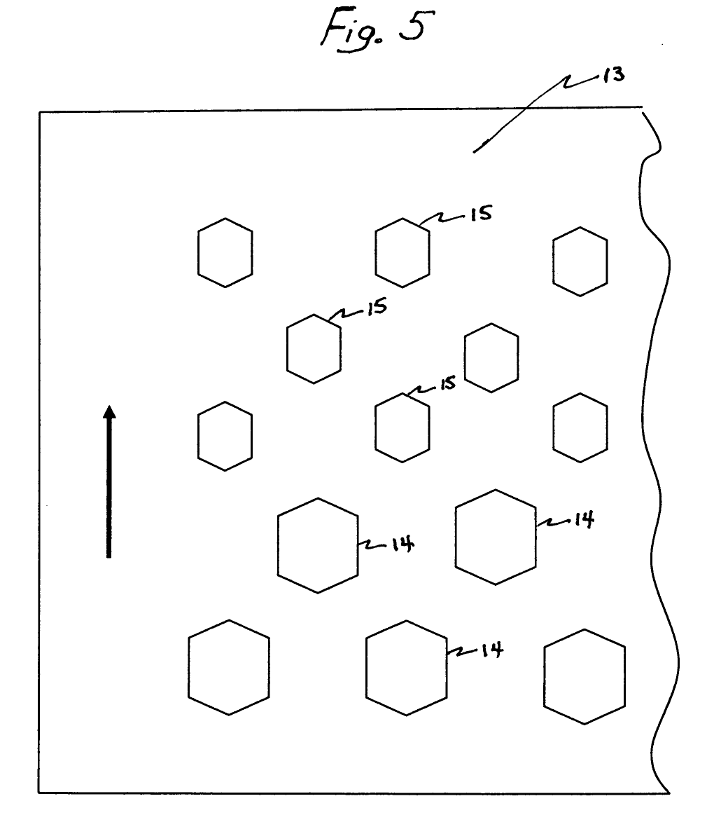

In FIG. 4, the first solder nozzle 10 has incorporated the invention and is now a wide solder wave 12, which is parallel to the travel of the conveyor 2, which carries the electronic substrate 20 to be soldered. The top plate 13 of the wide nozzle 12 is shown in more detail in FIG. 5, but the wide nozzle has from 3 to 9 rows of multi-sided holes to form a wave with very strong vertical impingement of solder to the product in addition to a long contact time. The vertical impingement creates an improvement in the efficiency of getting heat into the solder joint. Direct comparison tests have shown that improvement to be near 20% with all other conditions equal. Because the invention also requires a higher volume of solder than the narrow, current art nozzle, the energy drawn from the solder wave going into the product is replenished at a faster rate. Solder joints now form faster.

Between FIG. 3 and FIG. 4 the net result is a wave solder machine system that can run at a faster speed, meeting production run rates without additional machines, and providing fewer defects.

FIG. 5 is an expanded view detail of the invention first wave former, and is actually the crux of the invention claims. The top plate is from 2″ to 4″ wide with 3 to 9 rows of multi sided holes. The holes are not round nor oval nor square nor rectangular, and are typically hexagon although other multi-sided shapes could be used. The hexagon shape is used to reduce the clogging seen with other shaped holes. The arrow shown on the wave former plate 13 indicates the travel direction of the electronic substrate being processed over the solder wave. There is a distinction to the size of the apertures, as in holes 14 versus 15. Being designed to run at an angle from 3 to 7 degrees, the hole size differences equalize the height of the solder coming out of the different holes. Without a correction in the solder flow forces, the height of the solder wave along its width would change, reducing the solder pressure at the entry end of the nozzle. This reduction in effective height directly reduces the effect of the vertical impingement of solder against the substrate. The vertical impingement of solder against the electronic substrate is a design feature that allows this nozzle to be more effective with lead-free solder, and to form solder joints faster than current art.

Because of the increased solder contact length and this thermal transfer efficiency most TH solder joints can be formed while over the first solder wave. The issue of oxidation above the partial solder joint and the distance to the second solder wave are eliminated. The second solder wave is retained mostly to remove excess solder.

The embodiments of the present invention in which an exclusive property or privilege is claimed are defined as follows:

1. In the machine system used for the process of wave soldering, the invention is the first wave-soldering nozzle that by virtue of its design improves the speed and quality of the wave soldering process. The atmosphere around the solder station may or may not be controlled. A second wave-soldering nozzle may or may not be used.

2. The flat plate that forms the top of the first wave-soldering nozzle has a plurality of multi-sided openings therein to generate a first solder wave of extended contact for the electronic substrate being soldered. The widthwise dimension of the plate is between 2 and 4 inches. The openings are neither round, oval, square or rectangular, but multi-sided most often hexagon in shape.

3. In that flat plate with the plurality of multi-sided openings that forms the top of the first wave-soldering nozzle the sizes of the holes in each row of holes vary in size.
